(19) United States
(12) Patent Application Publication
(10) Pub. No.: US 2026/0218684 A1
(43) Pub. Date: Jul. 30, 2026

(54) METHOD OF RECONDITIONING A COMPOSITE BODY

(71) Applicant: VESTAS WIND SYSTEMS A/S, Aarhus N (DK)

(72) Inventors: Benjamin GREEN, Isle of Wight Newport (GB); Payam JAVADIAN, Aarhus N (DK)

(21) Appl. No.: 19/150,306

(22) PCT Filed: Jan. 31, 2024
(86) PCT No.: PCT/DK2024/050019

§ 371 Date: Jul. 23, 2025

(30) Foreign Application Priority Data
Jan. 31, 2023 (DK) PA202370055

(51) Int. Cl. F03D 80/50; B29C 73/02; B29C 73/24; B29K 63/00; B29L 31/08

(52) U.S. Cl. CPC F03D 80/502; B29C 73/02; B29C 73/245; B29K 2063/00; B29L 2031/085; F05B 2230/80

(57) ABSTRACT

According to the present invention there is provided a method of reconditioning a composite body (10) comprising at least one layer of reinforcing material (12) embedded in a thermoset epoxy matrix (14) having a crosslinked network structure. The method comprises identifying a region (16) of the composite body (10) for reconditioning; arranging a temporary barrier (18) on a surface of the composite body (10) to define an application area (22) comprising the identified region (16). The method further comprises applying a dissociation fluid (24) to the surface of the composite body (10) in the application area (22) to at least partially degrade the thermoset epoxy matrix (14) in the application area (22) to thereby dissociate one or more layers of reinforcing material (12) from the thermoset epoxy matrix (14).

### TECHNICAL FIELD

The present invention relates to composite bodies comprising at least one layer of reinforcing material embedded in a thermoset epoxy matrix, and more specifically to a method of reconditioning such a composite body.

### BACKGROUND

Composite materials, such as fibre reinforced plastics, are used in many applications for their advantageous strength and weight properties. For example, wind turbine blades are typically made from composite materials such as glass fibre reinforced plastic and carbon fibre reinforced plastic. Whilst the properties of such composite materials may be particularly advantageous in use, reconditioning such composite bodies, i.e. for repairing damage or attaching new components thereto, can be challenging.

For example, a typical repair operation may involve cutting or grinding away a region around the damaged portion to form a recess in the surface of the composite body. New repair material, such as epoxy resin and reinforcing fibres may then be arranged in the recess to repair the composite body. However, in many examples a tapered recess which is significantly larger than the damaged region may be cut or ground from the composite body in order to ensure that loads are transferred gradually between the existing material of the composite and the new repaired region in use. As such this requires time-consuming removal of composite material, and also requires more repair material for filling the recess. Further, in some examples, the damage may be a delamination of reinforcing material in the composite body, whilst the reinforcing material itself remains intact. Cutting and/or grinding such intact reinforcing material is therefore wasteful.

In some other examples a repair patch of composite material may simply be attached to the composite body over the damaged region. Whilst this may provide alternative load paths for loads to bypass the damaged region, the damaged material remains as part of the composite body. As such, a weak point and stress concentration remains, and crack propagation from the damaged region could cause further damage in use.

Further, composite bodies formed of fibre reinforced plastic typically exhibit a substantially smooth and hard, non-porous surface. As such, it can be challenging to achieve a high quality bond when attaching, i.e. bonding, components to such composite bodies.

It is against this background that the present invention has been developed.

### SUMMARY

According to the present invention there is provided a method of reconditioning a composite body comprising at least one layer of reinforcing material embedded in a thermoset epoxy matrix having a cross-linked network structure. The method comprises identifying a region of the composite body for reconditioning, and arranging a temporary barrier on a surface of the composite body to define an application area comprising the identified region. The method further comprises applying a dissociation fluid to the surface of the composite body in the application area to at least partially degrade the thermoset epoxy matrix in the application area to thereby dissociate one or more layers of reinforcing material from the thermoset epoxy matrix.

In some preferred examples, the reinforcing material may comprise fibrous reinforcing material, such as carbon fibres, glass fibres, aramid fibres, or other reinforcing fibres. Accordingly, the composite body comprising reinforcing fibres embedded in a thermoset epoxy matrix, may be described as comprising fibre-reinforced polymer in some examples. In particular, in some examples the reinforcing material may comprise one or more manufactured sheets, plies or mats of fibrous reinforcing material. For example, the composite body may comprise any of one or more plies of woven reinforcing fibres, one or more plies of fibre fabric material, one or more plies of unidirectional fibrous material (i.e. with reinforcing fibres extending in one direction), one or more plies of multi-axial fibrous material (i.e. with reinforcing fibres extending in multiple selected directions, such as biaxial or triaxial fibrous material), or one or more chopped strand mats such as felts or veils, to name some possible non-limited examples.

In some examples, the reinforcing material may comprise fibres selected from one or more of synthetic fibre semi-synthetic fibre, regenerated fibre, plant fibre, carbon fibre, rock fibre, glass fibre, and/or metal fibre. In some preferred examples, the fibres may be in the form of at least one sheet comprising fibres, for example at least one sheet comprising fibres embedded in a polymer which is different from the thermoset epoxy matrix.

In some examples, the reinforcing material may comprise metal, such as steel, aluminium, titanium, chromium, cobalt, nickel, copper, zinc, tin, or lead. Further, the reinforcing material may comprise an alloy comprising at least one of the aforementioned metals. In examples wherein the reinforcing material comprises metal, such metal reinforcing material may preferably be in the form of a grid, mesh, or wire.

The thermoset epoxy matrix of the composite body may comprise an epoxy based on at least one reactant comprising at least one epoxy resin. The epoxy resin may have been cured by heat or irradiation (e.g. ionization, IR-radiation, e-beam etc.). Additionally or alternatively the epoxy resin may have been cured by being exposed to or combined with at least one hardener, such as one or more anhydride curing agent, and/or one or more thiol curing agent, and/or one or more amine curing agent. In some preferred examples the thermoset epoxy matrix may not include a disulphide bridge moiety. It was found that for composite bodies with a thermoset epoxy matrix cured by an amine curing agent, a dissociation fluid comprising formic acid were particularly efficient at degrading the thermoset epoxy matrix in the application area, which allowed for very mild reaction conditions (such as acid concentration and temperature) and/or short treatment time as compared to a dissociation fluid with other acids.

In some examples, the composite body may be described as comprising a composite laminate structure because the plurality of layers of reinforcing material are laminated together by the thermoset epoxy matrix. Further, in some examples, the composite body may comprise a sandwich structure, with one or more components such as a lightweight core material or composite layers sandwiched between an inner skin and an outer skin of the composite body.

The temporary barrier advantageously constrains the dissociation fluid to the application area such that only the thermoset epoxy matrix in the application area is at least partially degraded by applying the dissociation fluid to the surface of the composite body. As such, the temporary barrier facilitates accurate application of the dissociation fluid to the composite body without damaging the composite body outside of the application area. The temporary barrier is therefore preferably formed of a material that does not react with, and/or is not permeable and/or degraded i.e. swelled or dissolved by, the dissociation fluid.

In some preferred examples, the temporary barrier may be substantially continuous, i.e. the application area may be entirely enclosed by the temporary barrier. As such, the temporary barrier may define a substantially continuous perimeter of the application area. In some examples, the temporary barrier may comprise a plurality of barrier components which together define the application area. In some examples each of the barrier components may physically contact at least one other barrier component such that the temporary barrier formed by the barrier components may be substantially continuous. Alternatively, in some examples the temporary barrier may comprise a small gap between adjacent barrier components.

In some examples, the temporary barrier may comprise an adhesive tape, preferably a thick adhesive tape, arranged on the surface of composite body. In some examples the temporary barrier may comprise a sealant, such as a silicone sealant, and/or a putty. In some other examples, the temporary barrier may comprise a patch comprising a reservoir, such as a cloth reservoir, in a central part of the patch. The patch may comprise dissociation fluid pre-arranged in the reservoir prior to arrangement of the patch on the surface of the composite body. The patch may comprise an adhesive, such as an adhesive tape extending around a perimeter of the reservoir, i.e. around the edge of the cloth, for temporarily securing the patch to the surface of the composite body.

As noted above, the dissociation fluid is applied to the surface of the composite body in the application area to at least partially degrade the thermoset epoxy matrix. As used herein, unless otherwise stated partially degrading the thermoset epoxy matrix comprises breaking down the cross-linked network structure of the thermoset epoxy matrix such that the epoxy loses its structural integrity and therefore does not bond the constituent components of the composite body, i.e. the layers of reinforcing material, together. For example, degrading the thermoset epoxy matrix may comprise dissolving the epoxy matrix in some examples to release, i.e. dissociate, the layers of reinforcing material from the epoxy. Alternatively, in some examples degrading the thermoset epoxy matrix may comprise swelling the epoxy matrix as described later in more detail.

In some examples, the dissociation fluid may be a swelling fluid. In such an example, applying the dissociation fluid to the surface of the composite body in the application area may comprise applying a swelling fluid to the composite body to swell the thermoset epoxy matrix in the application area.

It should be understood that, as used herein, references to “swelling” and equivalent terms refer to the entrance, i.e. penetration, of the swelling fluid into the thermoset epoxy matrix, without complete dissolution of the thermoset epoxy matrix, to open up or expand the crosslinked network structure of the thermoset epoxy matrix in a spatial sense, causing an increase in size and/or mass of the composite structure.

As used herein, the term “swelling fluid” should be understood to mean a fluid comprising formic acid and being capable of swelling and/or decomposing the thermoset epoxy matrix. In some preferred examples, the swelling fluid may be at least partially liquid, i.e. in a liquid state, when applied to the surface of the composite body. Whilst it should be understood that the swelling fluid may comprise a mixture of gaseous fluid and liquid fluid when applied to the surface of the composite body in some examples, in some particularly advantageous examples the swelling fluid may be liquid when applied to the surface of the composite body.

Applying the swelling fluid to the surface of the composite body to swell the thermoset epoxy matrix advantageously facilitates penetration of the swelling fluid into the network structure of the thermoset epoxy matrix. Over time, swelling the thermoset epoxy matrix mechanically breaks up the network structure of the thermoset epoxy matrix to form a multitude of thermoset epoxy fractions liberated from the layers of reinforcing material, thereby releasing, i.e. dissociating the layers of reinforcing material from the thermoset epoxy matrix.

The method may therefore comprise allowing the swelling fluid to soak into the composite body for a sufficient time period to allow the swelling fluid to mechanically break up the network structure of the thermoset epoxy matrix. In some examples, the method may therefore comprise allowing the swelling fluid to soak into the composite body for up to 144 hours, preferably for between 1 hour and 130 hours, more preferably for between 10 hours and 100 hours, more preferably for between 24 hours and 96 hours, more preferably for up to 72 hours, more preferably for up to 48 hours.

As noted previously, in some preferred examples the dissociation fluid may comprise formic acid. In some examples, the dissociation fluid may comprise at least 20 wt-% formic acid, preferably at least 50 wt-% formic acid, more preferably at least 80 wt-%.

Formic acid may also be referred to as methanoic acid. At 20° C. and 1 atm the formic acid is in a liquid state. The concentration of formic acid in the dissociation fluid may be selected based on the composition and/or crosslinking density of the thermoset epoxy matrix.

Alternatively, in some other examples the dissociation fluid may be a chemical disassembler fluid. The chemical disassembler fluid comprises acetic acid and/or formic acid. Accordingly, applying the dissociation fluid to the surface of the composite body in the application area may comprise applying a chemical disassembler fluid to the surface of the composite body to dissolve the thermoset epoxy matrix in the application area. This is particularly the case when the thermoset epoxy matrix is a chemically disassemblable epoxy type resin.

In some examples, the dissociation fluid may comprise one or more additional components, in addition to the formic acid and/or acetic acid. As such, the dissociation fluid may be an aqueous solution comprising formic acid and/or acetic acid. Additional components of the dissociation fluid may include at least one additional organic acid, such as trifluoroacetic acid, trichloroacetic acid, propionic acid, methanesulfonic acid, trifluoromethanesulfonic acid, performic acid or an anhydride of any of such organic acids. Additionally or alternatively, the one or more additional components may include at least one inorganic acid, such as hydrochloric acid. Further, in some examples the one or more additional components may comprise at least one alcohol, such as methanol, ethanol, propanol, isopropanol, butanol, t-butanol, or amyl alcohol.

With reference still to examples wherein the dissociation fluid may comprise one or more additional components, in some examples the one or more additional components may comprise an additional solvent. For example, the dissociation fluid may comprise one or more of tetrahydrofuran (THF), dimethylformamide (DMF), N-Methyl-2-pyrrolidone (NMP), dimethyl sulfoxide (DMSO), dichloromethane, chloroform, acetone, acetonitrile, chlorobenzene, diethylether, dioxane, ethylene glycol, polyethylene glycol (PEG), glycerine, hexamethylphosphoramide (HMPA), nitromethane, pyridine, trimethylamine, toluene, xylene, benzene, dimethylacetamide (DMAc), dimethoxyethane (DME), diglyme or dichloroethane. Dissociation fluid comprising an additional solvent may be a single phase or a phase fluid system.

In some examples the one or more additional components in the dissociation fluid may comprise at least one dissolved salt, such as NaCl, KCl, CsCl, NaHCO3, KHCO3, CsHCO3, Na2CO3, K2CO3, Cs2CO3, any salt comprising a quaternary ammonium cation, or any salt comprising either a tetrafluoroborate anion or hexafluorophosphate anion. Further, in some examples the dissociation fluid may comprise an additional component that comprises at least one surfactant, preferably selected from anionic and/or non-ionic surfactant, such as sulfates, sulfonates, gluconate, cocamide, ethoxylates, and/or alkoxylates.

It will be appreciated that in some examples, the method may comprise selecting the type and/or amount of the at least one additional component based on the constituent components of the composite body, such as the layers of reinforcing material, to ensure that application of the dissociation fluid to the surface of the composite body does not cause any substantial solvation or disintegration of the constituent components.

It will further be appreciated that in other examples, the method may comprise selecting the type and/or amount of the at least one additional component based on the constituent components of the composite body, such as a coating of the composite body, to ensure that application of the dissociation fluid to the surface of the composite body will lead to solvation or disintegration of the constituent components, particularly where the such constituent component may prevent or slow down degrading of the epoxy matrix by the dissociation fluid.

In some preferred examples the combination of components and any reaction components does not include a disulphide bridge moiety. In some preferred examples the dissociation fluid may have a pH value at least 2, for example the dissociation fluid may have a pH value between 2.5 and 4.

In some preferred examples, the dissociation fluid may be applied to the surface of the composite body at a fluid temperature of between 10° C. and 35° C., preferably between 20° C. to 27° C. The dissociation fluid is preferably applied to the surface of the composite body at atmospheric pressure or at elevated pressure conditions.

In some examples, the identified region may be a damaged region of the composite body. After applying the dissociation fluid to the surface of the composite body in the application area the method may further comprise arranging one or more repair materials in the identified region. Accordingly, the method described herein may be a method of repairing a composite body.

In some examples, the damaged region may comprise a delamination, i.e. separation, of the layers of reinforcing material in the thermoset epoxy matrix. The epoxy matrix bonding the layers together may have cracked and/or failed such that the bond between adjacent layers of the composite body is broken. By at least partially degrading the thermoset epoxy matrix, the dissociation fluid applied to the application area may advantageously loosen the thermoset epoxy matrix from the or each layer of reinforcing material for removal of the damaged epoxy in preparation for the arrangement of repair materials in the identified region to repair the damage.

In some examples, the one or more repair materials may comprise epoxy resin. For example, the method may comprise supplying epoxy resin to the application area. In some examples, the epoxy resin may be supplied to the application area under pressure, for example in an injection method. In some other examples, the epoxy resin may be supplied to the application area in an infusion process, such as vacuum assisted resin infusion. In some other examples, the epoxy resin may be supplied to the application area by dispensing or painting the epoxy resin onto the application area and then manipulating it into the reinforcement. Epoxy resin supplied to the application area may replace the at least partially degraded thermoset epoxy matrix resulting from the application of the dissociation fluid to the surface of the composite body.

In some examples the damaged region may comprise damage to the thermoset epoxy matrix, but the one or more layers of reinforcing material may not be damaged. The dissociation fluid applied to the application area at least partially degrades the thermoset epoxy matrix to dissociate one or more layers of reinforcing material from the thermoset epoxy matrix. Accordingly, the application of the dissociation fluid to the application area of the composite body may therefore facilitate removal of the thermoset epoxy matrix in the identified region, whilst leaving the existing reinforcing material of the composite body in place.

Removal of damaged epoxy from the application area may involve forming an opening in at least one layer of reinforcing material wherethrough swelled epoxy particles or dissolved epoxy segments may be removed from the application area. The opening may for example be formed by cutting selected reinforcing material or forcing reinforcing material away from the opening.

In some examples, after applying the dissociation fluid to the application area and before supplying epoxy resin to the application area, the method may further comprise activating the reinforcing material of the composite body in the application area. Reinforcing materials, such as fibrous reinforcing materials, are typically activated before being embedded in epoxy resin during manufacture of a composite body. Such activation may involve any of roughening the reinforcing material for example by sanding, applying a surface coating or primer to the reinforcing material, or other chemical preparation of the reinforcing material, for example cleaning with a solvent. Activating the existing reinforcing material in the application area advantageously improves adhesion between the epoxy resin supplied to the application area and the existing reinforcing material of the composite body.

In some examples, the repair materials may comprise reinforcing material. In some preferred examples, the reinforcing material arranged in the identified region may be substantially equivalent to the reinforcing material of the composite body in the identified region. As such, the reinforcing material introduced to the composite body preferably matches the existing reinforcing material of the composite body. Matching the materials helps to minimise the risk of stress concentrations and/or weak points between the new reinforcing material and the existing reinforcing material embedded in the thermoset epoxy matrix of the composite body.

In some examples, arranging reinforcing material in the identified region may comprise arranging a layer of fibrous reinforcing material in contact with existing reinforcing material embedded in the thermoset epoxy matrix of the composite body. For example, arranging the reinforcing material may comprise arranging a layer of reinforcing material on top of or underneath an existing layer of reinforcing material, or between two layers of existing reinforcing material. Such an arrangement may advantageously provide a direct load path between the existing reinforcing material of the composite body and the new reinforcing material arranged in the identified region for advantageous structural performance.

In some examples, the method may comprise removing reinforcing material, such as damaged reinforcing material, from the identified area after applying the dissociation fluid to the application area. In some preferred examples, reinforcing material removed from the identified area, such as damaged reinforcing material, may be replaced by substantially equivalent reinforcing material which in some preferred examples may be arranged in substantially the same orientation as the removed reinforcing material. This helps to ensure that the composite body is repaired to the original design intent to ensure optimal performance of the repaired composite body, in particular in terms of compressive and tensile strength.

It will be appreciated that in some preferred examples, the method described herein facilitates a simple assessment of the existing reinforcing material in the identified region of the composite body. For example, where the thermoset epoxy matrix is dissociated from the or each layer of reinforcing material in the identified region, an assessment of that reinforcing material can then be made. As such when repairing the damaged region, a simple assessment and determination can be made to select substantially equivalent reinforcing material, before such reinforcing material is subsequently arranged in a substantially equivalent orientation to the existing and/or removed reinforcing material.

Additionally, the method described herein minimises unnecessary damage to the composite body when repairing the damaged region. As described by way of background, previous repair methods may require extensive grinding operations to remove material around the damaged region. For example such previous repair methods may involve forming a comparatively large, chamfered recess, to investigate the type and orientation of reinforcing materials required for the repair, and to ensure that loads are transferred gradually between the composite body and materials of the repaired region in use. Accordingly, previous methods may necessitate the removal of undamaged reinforcing material, whereas the method described herein may facilitate repair of the composite body without unduly removing or damaging the undamaged reinforcing material of the composite body, or at least minimising any such damage. This may reduce cost and time required for repairs, whilst also improving the structural integrity and performance of any such repair.

In some examples, the method may additionally or alternatively include arranging a repair patch of reinforcing material over the identified region. For example, the repair patch may comprise fibrous reinforcing material, such as glass fibres or carbon fibres for example. A repair patch may further strengthen the repaired area and may provide additional load paths for transferring loads in use, thereby reducing loading of the new and/or existing reinforcing material in the identified area of the composite body.

In some examples, the temporary barrier may comprise sealing apparatus. As such, the method may include arranging the sealing apparatus to cover the identified region and engaging a seal of the sealing apparatus against the surface of the composite body. Engaging the seal of the sealing apparatus against the surface of the composite body may define an epoxy supply volume between the sealing apparatus and the identified region. The method may comprise supplying epoxy resin to the epoxy supply volume when repairing the composite body.

In some preferred examples, the sealing apparatus may be vacuum sealing apparatus. Accordingly, the method may additionally comprise evacuating the epoxy supply volume under vacuum pressure before supplying epoxy thereto. Vacuum sealing apparatus may advantageously minimise or prevent leakage of the dissociation fluid, ensuring the dissociation fluid is contained to treat only the intended application area.

In some examples, the method may further comprise assessing the application area to specify an amount of thermoset epoxy matrix for removal. Further, the method may include measuring a quantity of the dissociation fluid corresponding to the specified amount of thermoset epoxy matrix for removal. The method may comprise applying the measured quantity of dissociation fluid to the application area to remove a pre-specified amount of thermoset epoxy matrix.

As used herein, an amount of thermoset epoxy matrix may refer to a volumetric amount, i.e. a volume, of material. The ratio of amount of dissociation fluid to amount of thermoset epoxy matrix removed may be a known characteristic of the dissociation fluid, for example from empirical testing of the dissociation fluid. Accordingly, after the amount of thermoset epoxy matrix for removal has been specified, the quantity of dissociation fluid corresponding to the specified amount of thermoset epoxy matrix for removal can be measured and supplied to the application area to control or limit the amount of epoxy material dissociated from the reinforcing material in the application area.

In some examples, the dissociation fluid may comprise at least one of a dissolved dye, a colourant, a pigment, or a UV sensitive component. Any such addition to the dissociation fluid may be advantageous for indicating the presence of any dissociation fluid in the application area. For example, such additions may facilitate a simple assessment of whether the dissociation fluid has been sufficiently removed, i.e. cleaned or rinsed, from the composite body before any new epoxy or reinforcing material is arranged in the identified region. Further, this may clearly indicate if all damaged resin has been removed by the dissociation fluid from an area inflicted by a delamination since dissociation fluid in a crack would be easier visible due to the colour of the dissociation fluid.

In some examples, the method may further comprise applying a neutralising agent to the composite body in the application area to neutralise the dissociation fluid and thereby stop the dissociation reaction between the fluid and the thermoset epoxy matrix. In some preferred examples, the neutralising agent may be applied to the composite body prior to the arrangement of one or more repair materials in the identified region. This further helps to ensure that the dissociation reaction is stopped prior to the introduction of new epoxy resin.

The neutralising agent may be in a gaseous state when applied to the composite body in the application area. In some other examples, the neutralising agent may be an aerosol when applied to the composite body in the application area. In some preferred examples, the neutralising agent may comprise a pH sensitive indicator. This may help to provide a visual indication of when the dissociation fluid is sufficiently neutralised to stop the dissociation reaction. In some examples, the neutralising agent may comprise water. In some examples the neutralising agent may be a solvent. In some examples the neutralising agent may be an aqueous solution containing a weak base.

After applying the dissociation fluid to the surface of the composite body in the application area the method may further comprise a mechanical cleaning process to remove substantially all fluid and/or debris from the identified region. In some examples, the mechanical cleaning process may comprise the application of vacuum suction and/or pressurised air to the identified region. In some examples, the mechanical cleaning process may comprise dry ice (CO2) blasting. In some examples, the mechanical cleaning process may comprise brushing the identified region. To facilitate the cleaning process, openings may be formed in one or more fibre layers to enhance transport into and from the surface of the composite.

In some preferred examples, the mechanical cleaning process may be performed prior to the arrangement of one or more repair materials in the identified region. This helps to provide a clean and stable surface for bonding each repair material to the composite body. Further, in some preferred examples the mechanical cleaning process may be performed after the application of a neutralising agent to the composite body in the application area. As such, the mechanical cleaning process may also be advantageous for removing the neutralising agent from the identified region of the composite body.

In some examples, the composite body comprises a cover layer on the identified region and the cover layer is inert to the dissociation fluid. The cover layer may for example be a coating or a shield, and typically the cover layer does not comprise a thermoset epoxy matrix. By being inert to the dissociation fluid is here meant that the cover layer is not significantly degraded by exposure to the dissociation fluid. The cover layer will therefore typically prevent or delay the degrading of the thermoset epoxy matrix by the dissociation fluid, thereby prevent or make the method of the invention slow or inconsistent. In this example, then method comprises removing the cover layer on the identified region prior to applying the disassociation fluid to the surface of the surface of the composite body. Removing of the cover layer preferably comprises mechanically removing for example by abrading such as grinding or polishing, and/or by cutting the cover layer. Other method for removing the cover layer may involve thermal treatment (such as melting or evaporating), chemical treatment or a combination of two or more of these. If a cover layer has been removed from the identified region, then it is preferred to apply a replacement cover layer after applying the dissociation fluid to the surface of the composite body in the application area. The replacement cover layer is typically applied after one or more repair material has been arranged in the identified region, so the reconditioned composite body resembles the original non-reconditioned composite body possibly with the exception that the applied repair material may improve properties of the reconditioned composite body as compared to the non-conditioned composite body.

In some examples, the surface of the composite body may be an external surface such that the dissociation fluid is applied to an external surface of the composite body.

In some examples, the composite body may be at least part of a means of transport, i.e. a vehicle, such as a floating vessel, an aircraft, or a road vehicle for example. In some other examples, the composite body may at least part of an item of sporting equipment, such as a ski, a kayak, a bicycle, a helmet, or a tennis racket for example. The method may be particularly advantageous in examples wherein the composite body may be a wind turbine component.

For example, in some examples the composite body may be a nose cone of a wind turbine rotor, a spinner, or part of a hub. Alternatively, the composite body may be a nacelle cover or housing, part of a tower of a wind turbine, such as a tower wall, a tower platform, or a hatch. In some particularly advantageous examples, the wind turbine component may be a wind turbine blade component. For example, the wind turbine blade component may be a composite reinforcing structural component of the wind turbine blade, in some examples.

In some particularly advantageous examples the composite body may be a composite wind turbine blade. As such, it will be appreciated than in some examples, the method of reconditioning a composite body described herein may be a method of reconditioning a composite wind turbine blade. Wind turbine blades are typically exposed to harsh weather conditions, and may be damaged in use, for example as a result of lightning strikes, erosion and impact damage. Accordingly, the identified region referred to herein may be a damaged region of a composite wind turbine blade, such as a wind turbine blade shell, a web of a wind turbine blade, a root section of a wind turbine blade, a tip of a wind turbine blade or a leading edge of a wind turbine blade.

In some examples, prior to applying a dissociation fluid to the surface of the composite body in the application area, the method may include arranging the composite wind turbine blade in a substantially vertical orientation, i.e. with its longitudinal axis extending substantially vertically, to minimise loading and stresses on the composite blade during and after application of the dissociation fluid to the application area.

In some examples, the composite body may be a composite wind turbine blade comprising an aerodynamic outer profile extending in a chordwise direction between a leading edge and a trailing edge. The leading edge may define a leading edge region, and the method may comprise identifying the leading edge region as the region of the composite body for reconditioning. The temporary barrier may be arranged on the surface of the composite body to define an application area comprising the leading edge and the leading edge region. As such, it will be appreciated than in some examples, the method may be a method of reconditioning a leading edge region of a composite wind turbine blade.

In some examples, the leading edge region may extend up to 0.05 C, preferably up to 0.10 C, more preferably up to 0.15 C from the leading edge in the chordwise direction, where C is the chord, i.e. the distance between the leading edge and the trailing edge at a spanwise location along the blade. In some examples, the leading edge region may extend up to 0.1 m, preferably up to 0.2 m, more preferably up to 0.3 m from the leading edge in the chordwise direction.

It will be appreciated that the wind turbine blade comprises a windward (pressure) side and a leeward (suction) side. The leading edge region preferably extends up to the above-stated chordwise distances on each of the windward and leeward sides of the blade. It should be noted than in some examples, the leading edge region may extend further on one side than the other. By way of a non-limiting example, the leading edge region may extend up to 0.3 m from the leading edge on the windward side, and up to 0.2 m from the leading edge on the leeward side.

In some examples, after applying the dissociation fluid to the surface of the composite body in the application area, the method further comprises attaching a leading edge protection component to the leading edge region of the composite wind turbine blade.

Accordingly, the method may be implemented as a surface preparation stage prior to attachment of a leading edge protection component to the blade surface. It will be appreciated that when the method of the present invention is used for reconditioning a leading edge region, then it may not be required to degrade the thermoset epoxy matrix in the application area so much that one or more layers of reinforcing material dissociate from the thermoset epoxy matrix. For example, the method may be used to at least partially degrade the thermoset epoxy matrix in a surface layer of the leading edge region, to a lesser degree whereby roughening, or chemically etching, the surface to facilitate improved subsequent adhesion of the leading edge component to the composite blade shell, e.g. without dissociating reinforcing material from the thermoset epoxy resin.

In some examples, after applying the dissociation fluid to the surface of the composite body in the application area, the method may include removing an existing leading edge protection component from the composite wind turbine blade surface. For example, the existing leading edge protection component may comprise an epoxy-based coating or a leading edge protection shield bonded to the wind turbine blade surface with an epoxy-based adhesive, in some examples. Applying the dissociation fluid in the application area may at least partially degrade the epoxy-based coating or adhesive, thereby facilitating removal of the existing leading edge protection component from the surface. Further, in some examples, the dissociation fluid applied to the surface of the composite wind turbine blade may at least partially degrade the thermoset epoxy matrix of the application area such that the existing leading edge protection component may be removed from the blade surface.

Accordingly, application of the dissociation fluid may facilitate simple removal of an existing leading edge protection component. In particular, the method may facilitate removal of an eroded or damaged existing leading edge protection component from the blade surface. In previous methods, such removal and/or surface preparation for attachment of a new leading edge protection component required significant grinding and/or sanding. Such processes are time-consuming, can be expensive, and may be difficult to perform up-tower. The method described herein is therefore advantageous over previous methods for one or more of these reasons.

Where implemented, the step of removing an existing leading edge protection component from the blade surface is preferably performed before the step of attaching a new leading edge protection component to the blade surface. It should be appreciated that the method may therefore be implemented as part of a method of removing, replacing, or attaching a leading edge protection component.

In some examples, after reconditioning the composite body, or at the end of the reconditioning method, the surface of the composite body in or near to the application area may be ground or polished. Further, in some examples the shape of the composite body may be adjusted, for example by applying a padding or a resin which is subsequently cured. In some examples, a coating may be applied to the composite body in or around the application area after reconditioning the composite body, or at the end of the reconditioning method.

### BRIEF DESCRIPTION OF THE DRAWINGS

Examples of the present invention will now be described by way of non-limiting example(s) only, with reference to the accompanying figures, in which:

FIG. 1 is a schematic perspective view of a composite wind turbine blade which is an example of a composite body comprising a region identified for reconditioning;

FIG. 2a is a schematic cross-sectional view of a stage in a reconditioning method comprising applying a dissociation fluid to an application area comprising the identified region;

FIG. 2b is a schematic cross-sectional view of the application area of the composite body following application of the dissociation fluid;

FIG. 3a is a schematic cross-sectional view of epoxy resin arranged in the identified region;

FIG. 3b is a schematic cross-sectional view of another example of repair materials arranged in the identified region;

FIG. 4 is a schematic cross-sectional view showing sealing apparatus arranged on the composite body to define the application area;

FIG. 5a is a schematic perspective view of a composite wind turbine blade comprising a leading edge region identified for reconditioning;

FIG. 5b is a schematic cross-sectional view of a surface preparation stage in a method of attaching a leading edge protection component to the leading edge region; and

FIG. 5c is a schematic cross-sectional view of the leading edge protection component being attached to the leading edge region.

### DETAILED DESCRIPTION

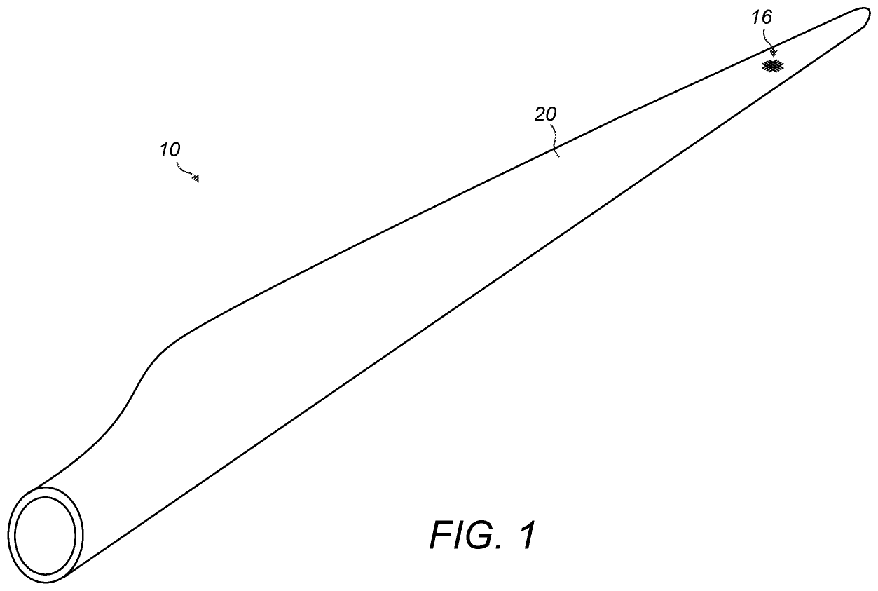

FIG. 1 shows a schematic perspective view of a composite wind turbine blade 10. The wind turbine blade 10 is an example of a composite body 10 which may be reconditioned in accordance with examples of a method described herein. Whilst examples of the method will be described initially in relation to a composite wind turbine blade 10, it will be appreciated that many examples of the method are equally applicable to other composite bodies. As such whilst reference is made herein primarily to a composite wind turbine blade 10, it should be appreciated that unless otherwise stated, references to a composite wind turbine blade 10, i.e. a blade, may be understood to refer more generally to a composite body 10, and a composite wind turbine blade 10 is merely an example of a composite body used for explaining the method.

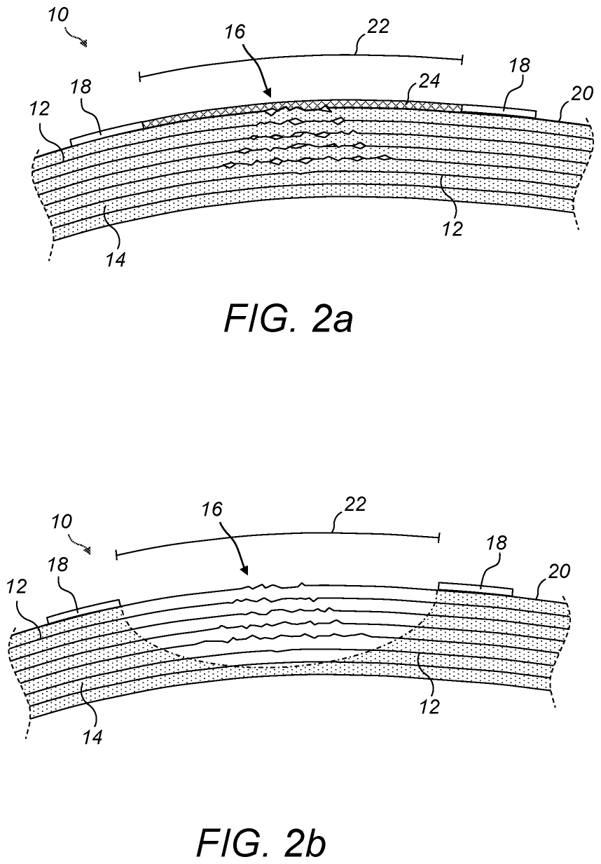

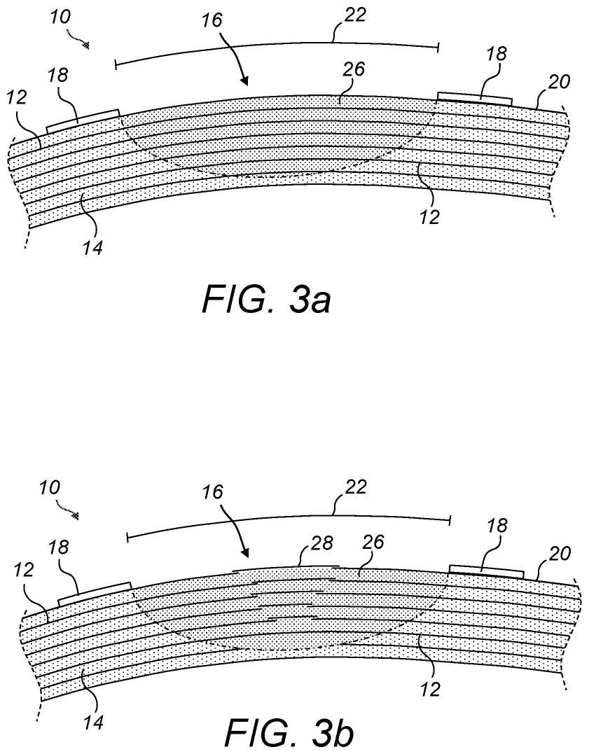

As shown more clearly in the cross-sectional views of FIGS. 2a to 3b, the blade 10, i.e. the composite body 10, comprises at least one layer of reinforcing material 12 embedded in a thermoset epoxy matrix 14 having a cross-linked network structure. In some preferred examples, such as those shown in the accompanying figures, the blade 10 may comprise a plurality of layers of reinforcing material 12 embedded in the epoxy matrix 14.

The examples of the method described herein are for reconditioning a composite body 10. Accordingly, the method includes identifying a region 16 of the composite body 10 for reconditioning. For example, the identified region 16 may be a damaged region of the composite body 10. With reference to FIG. 1, a blade 10 may comprise a damaged region 16 as a result of lightning strikes, or impact damage, to name two non-limiting examples.

After identifying the region 16 for reconditioning, the method includes arranging a temporary barrier 18 on a surface 20 of the blade 10 to define an application area 22 which comprises the identified region 16. In some examples, such as that shown in FIGS. 2a to 3b, the temporary barrier 18 may comprise adhesive tape, and such tape may be applied to the surface 20 of the blade 10 to define the application area 22.

Referring now primarily to FIG. 2a, the reconditioning method includes applying a dissociation fluid 24 to the surface 20 of the blade 10 in the application area 22. The dissociation fluid 24 at least partially degrades the thermoset epoxy matrix 14 in the application area 22, for example by swelling the epoxy 14 or by dissolving the epoxy 14. For example, the thermoset epoxy matrix 14 may be a traditional type epoxy resin which upon exposure to the dissociation fluid 24 may swell such that the epoxy disintegrates into swelled epoxy particles. Accordingly, the dissociation fluid 24 may be a swelling fluid, and in some examples the dissociation fluid may comprise formic acid to swell the epoxy matrix. Further, in some examples the thermoset epoxy matrix 14 may be a chemically disassemblable epoxy type resin, such as Recyclamine for example, which upon exposure to the dissociation fluid 24 may be broken into dissolvable epoxy fractions when the dissociation fluid is a chemical disassembler fluid. Accordingly, the dissociation fluid 24 may comprise acetic acid and/or formic acid to dissolve the epoxy 14 in the application area 22 in such an example.

It will be appreciated that the temporary barrier 18 arranged on the surface 20 of the composite body 10 is configured to constrain the dissociation fluid 24 to the application area 22, such that degradation of the thermoset epoxy matrix 14 is limited to the epoxy in the application area 22. The dissociation fluid 24 may be applied to the application area 22 and left to degrade the thermoset epoxy matrix 14 for a predetermined time period. Whilst not shown in the accompanying figures, after application of the dissociation fluid 24, some examples may include applying a neutralising agent to the composite body 10 in the application area 22 to neutralise the dissociation fluid 24. The neutralising agent may help to stop or significantly slow the dissociation reaction between the fluid 24 and the thermoset epoxy matrix 14, thereby facilitating control of degradation process.

Importantly, at least partially degrading the thermoset epoxy matrix 14 in the application area 22 facilitates the dissociation, i.e. separation, of one or more layers of reinforcing material 12 from the thermoset epoxy matrix 14. This means that in the application area 22 where the dissociation fluid 24 has been applied to the surface 20 of the composite body 10, the epoxy matrix 14 may be removed, as shown in FIG. 2b for example.

Some examples may include a mechanical cleaning process performed after the epoxy 14 is at least partially degraded to remove the degraded epoxy from the application area 22, and/or after the neutralising agent has neutralised the dissociation fluid 24, to remove the neutralising agent. For example, a mechanical cleaning process such as brushing or applying vacuum suction may be performed to remove substantially all fluid and/or debris from the identified region 16.

Whilst not shown in the accompanying figures, in some examples the dissociation fluid 24 may comprise an identification component, such as a dissolved dye, a colourant, a pigment, or a UV sensitive component. This may be helpful for providing an indication of when the identified region 16 has been sufficiently cleaned to remove all of the dissociation fluid 24.

Notably, as shown in FIG. 2b, in some advantageous examples, degrading the epoxy matrix 14 in the application area 22 releases the reinforcing material 12 of the composite body 10 from the epoxy 14 with the reinforcing material remaining 12 in place in the application area 22. In some examples this facilitates an examination of the existing reinforcing material 12, for example to identify the type, orientation, and number of layers of reinforcing material 12 in the identified region 16, and in some examples may also enable an assessment of any damage to the existing reinforcing material 12.

In examples where the identified region 16 is a damaged region, such as the example shown in FIGS. 1 to 3b, the method may facilitate repair of the damaged region 16 without necessitating additional damage to the composite body 10 or excessive removal of reinforcing material 12. For example, as shown in the cross-sectional view of FIG. 2a, the damaged region 16 may comprise a delamination of the layers of reinforcing material 12, i.e. a failure of the epoxy matrix 14, whilst the layers of reinforcing material 12 remain intact, i.e. undamaged.

With reference now to FIGS. 3a and 3b the method may include arranging repair materials in the identified region 16. For example, as shown in FIG. 3a, after degrading and removing the damaged epoxy 14 in the application area 22, the method may include supplying epoxy resin 26 to the application area 22. As described previously, in some advantageous examples the existing layers of reinforcing material 12 may remain intact in the identified region 16, and the reconditioning method may therefore simply replace the damaged epoxy material 14 with new epoxy resin 26.

It is preferred that reinforcing material is straightened during supplying and/or curing of epoxy resin. This may for example be achieved by putting tension on the damaged area or by forcing the fibres towards the surface or away from the surface during supplying and/or curing of the resin.

In some examples, as shown in FIG. 3b, one or more layers of reinforcing material 12 in the identified region 16 may be damaged or may have been removed. It will be appreciated that the method may therefore also include arranging one or more new layers of reinforcing material 28 in the identified region 16. Advantageously, as described above the method facilitates an examination of the existing reinforcing material 12 in the application area. As such, substantially equivalent reinforcing material 28 can be arranged in substantially the same orientation as the existing or replaced reinforcing material 12 in the identified region 16. This ensures that the composite body 10, for example the composite wind turbine blade 10, is returned to the original design intent in an example of the reconditioning method. In some examples (not shown), additional reinforcing material may be arranged in the identified region 16 to strengthen the identified region 16 beyond the original design intent, for example to reduce the risk of future damage in the same identified region 16.

In each of the examples described with reference to FIGS. 3a and 3b, wherein repair materials such as epoxy resin 26 and reinforcing material 28 are arranged in the identified region 16, it may be advantageous to activate, or re-activate the existing reinforcing material 12 of the composite body 10 in the identified region 16 prior to arranging the repair materials. For example, the existing reinforcing material 12 may be roughened or primed before the repair materials are arranged, to improve adhesion of any new epoxy resin 26 to the existing reinforcing materials 12.

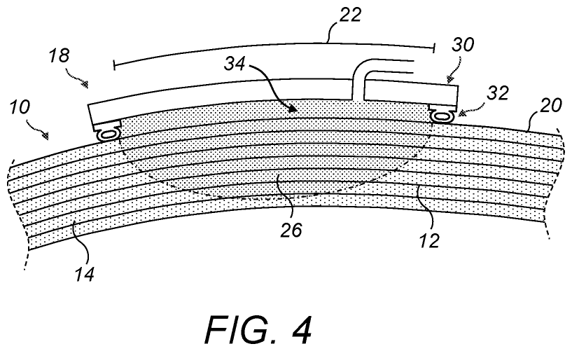

Referring now to FIG. 4, in some examples, the temporary barrier 18 configured to define the application area 22 may comprise sealing apparatus 30. For example, such sealing apparatus 30 preferably includes a seal 32, such as a deformable silicon or rubber seal, for arranging against the surface 20 of the composite body 10. As such, the reconditioning method may include arranging the sealing apparatus 30 to cover the identified region 16, and engaging the seal 32 against the surface 20 of the composite body 10.

With the seal 32 arranged against the surface 20 to define the application area 22, the sealing apparatus 30 may define an epoxy supply volume 34 (exaggerated for clarity in FIG. 4) between the sealing apparatus 30 and the identified region 16. When reconditioning the composite body 10, for example by repairing the damaged region 16, epoxy resin 26 may be supplied to the identified region 16 by supplying epoxy resin 26 to the epoxy supply volume 34. In some examples the resin 26 may be injected to the supply volume 34, or in other examples the resin 26 may be supplied under vacuum pressure, for example by first evacuating the epoxy supply volume 34.

A temporary barrier 18 comprising sealing apparatus 30 may advantageously facilitate accurate application of the dissociation fluid 24 to the application area 22, whilst protecting the remainder of the composite body 10 from the dissociation fluid 24. Further the sealing apparatus 30 may facilitate accurate supply of the dissociation fluid 24 to the application area 22 such that, in some examples, a measured quantity of dissociation fluid 24 may be supplied to the application area 22.

For example, the reconditioning method may include assessing the application area 22 to specify an amount of thermoset epoxy matrix 14 for removal. Knowing the amount of epoxy matrix 14 for removal, and knowing characteristics of the dissociation fluid 24 such as the degradation rate and/or ratio of amount of dissociation fluid 24 to amount of thermoset epoxy matrix 14 removed, the method may then include measuring a quantity of the dissociation fluid 24 corresponding to the specified amount of thermoset epoxy matrix 14 for removal. Subsequently the measured quantity of dissociation fluid 24 may be applied to the application area 22 to remove the pre-specified amount of thermoset epoxy matrix 14.

It will be appreciated that the above-described process of specifying, measuring, and applying an amount of dissociation fluid 24 is not limited to examples wherein the temporary barrier 18 comprises sealing apparatus 30. However, as noted previously, sealing apparatus 30 may be particularly advantageous for facilitating an accurate supply and application of dissociation fluid 24 to the application area 22.

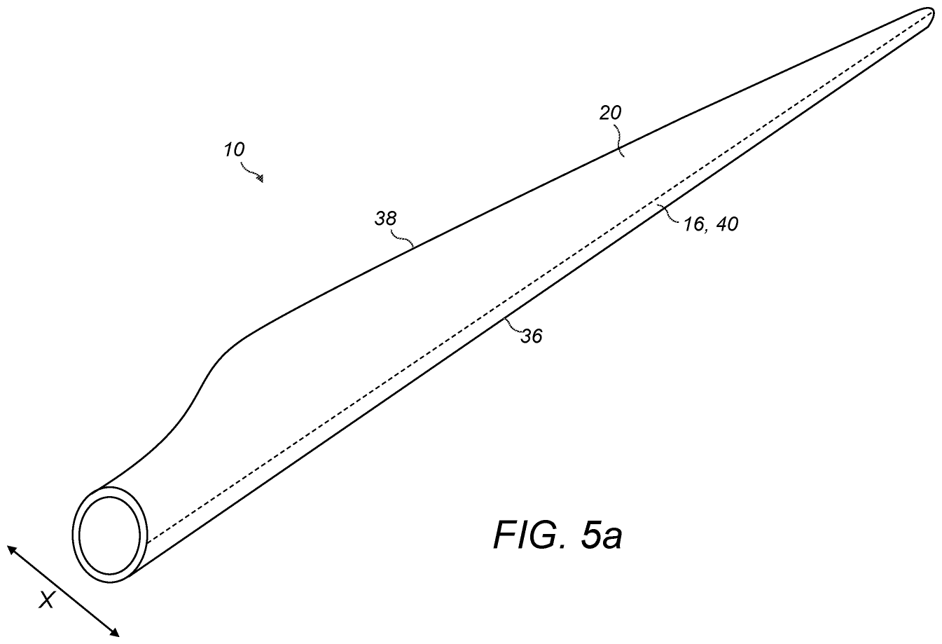

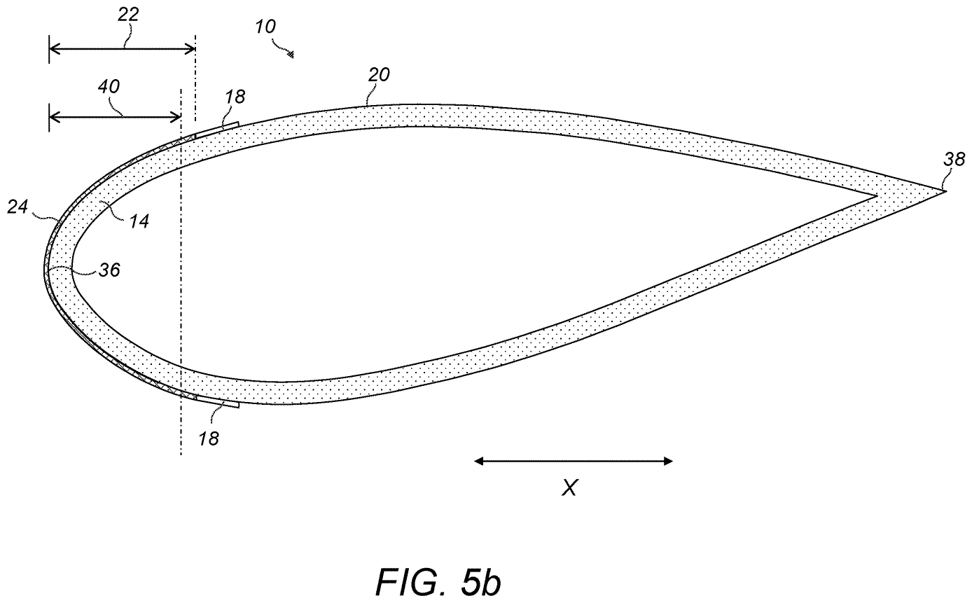

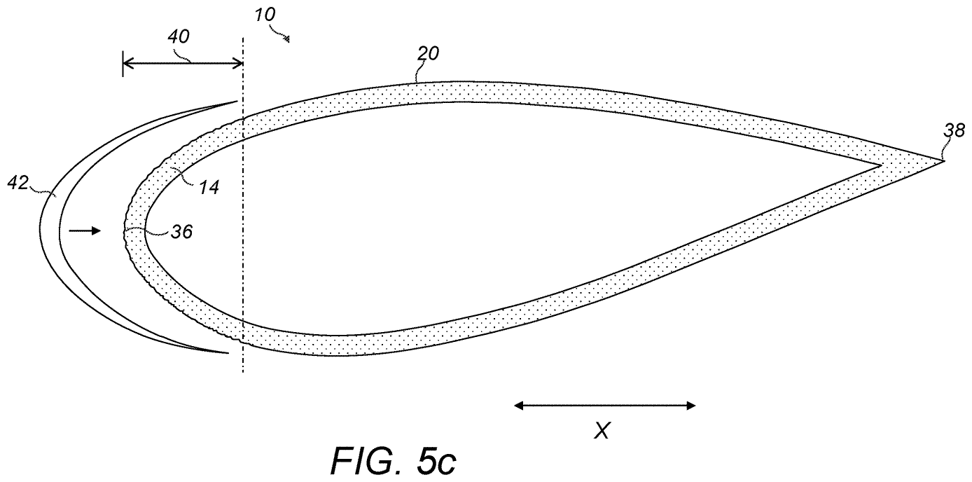

With reference now to FIG. 5a, some examples of the reconditioning method may be applicable more specifically to composite wind turbine blades 10. For example, as shown in FIGS. 5a to 5c, some examples of the method may be used to recondition a leading edge region of a composite wind turbine blade 10 as will now be described. It will be appreciated that whilst not shown in the figures for clarity, the composite wind turbine blade 10 in FIGS. 5a to 5c similarly comprises layers of reinforcing material embedded in a thermoset epoxy matrix having a cross-linked network structure. The cross-sectional views of FIGS. 2a to 4 are equally applicable to the examples shown in FIGS. 5a to 5c with regard to presence of reinforcing material 12 and epoxy matrix 14.

The composite wind turbine blade 10 preferably comprises an aerodynamic outer profile for extracting energy from wind incident on the blade 10 in use. The aerodynamic profile extends in a chordwise direction X between a leading edge 36 and a trailing edge 38. The leading edge 36 defines a leading edge region 40, which in some examples may extend up to 0.15 C from the leading edge 36 in the chordwise direction X, where C is the distance between the leading and trailing edges 36, 38, i.e. the chord length.

For reconditioning at least a part of a leading edge region 40 of a composite wind turbine blade 10 it follows that at least a part of the leading edge region 40 is identified as the identified region 16 of the composite body 10 for reconditioning. Accordingly, the temporary barrier 18, such as adhesive tape shown in the example of FIG. 5b, may be arranged on the surface 20 of the composite body 10 to define an application area 22 comprising the leading edge 36 and at least a part of the leading edge region 40.

Referring still to FIG. 5b, and as described previously with reference to other examples of the method, the dissociation fluid 24 is applied in the application area 22 to at least partially degrade the thermoset epoxy matrix 14 of the composite wind turbine blade 10. The degradation of the epoxy 14 in the application area 22 may result in a roughened surface in the leading edge region 40. Such a roughened surface may be advantageous for attaching a leading edge protection component 42 to the leading edge region 40, as shown in FIG. 5c. The partial degrading of the thermoset epoxy matrix at the leading edge may lead to one or more layers of reinforcing material dissociate from the epoxy resin or the degrading may be to a lesser level where the surface is only roughened without reinforcing material dissociate from the epoxy resin.

With reference to FIG. 5c, in the example shown the leading edge protection component 42 is a protection shield which may be bonded to the wind turbine blade 10 with an adhesive. As such, the method may include attaching a leading edge protection component 42 to the leading edge region 40 of the composite wind turbine blade 10. Roughening the surface 20 of the blade 10 by implementing the above described method as a surface preparation method may advantageously increase adhesion and/or quality of the bond between the protection shield 42 and the blade 10. In some other examples the leading edge protection component 42 may be a coating and similar advantages in terms of increased adhesion and longevity are equally applicable in such examples.

Whilst not shown in the accompanying figures, in some examples the method may also be used to remove an existing leading edge protection component from the composite wind turbine blade 10. For example, the dissociation fluid 24 applied in the application area 22 may degrade the existing leading edge component, and/or an adhesive bonding the existing leading edge component to the blade 10, and/or the epoxy matrix 14 of the composite blade 10 to which the existing protection component is attached, thereby facilitating removal of the existing component.

It will be appreciated that some examples of the reconditioning method, for example the methods of reconditioning a leading edge region 40 of a blade 10, are specifically applicable to composite wind turbine blades 10. However, other examples of the reconditioning method described previously are more widely applicable to other composite bodies 10. As such, some examples of the methods described herein may be advantageous for reconditioning composite bodies 10 such as kayaks, canoes, skis, or bicycle frames to name some other non-limiting examples. Further, whilst the examples of the method have been described with reference to a composite wind turbine blade 10, the method may also be suitable for reconditioning other composite wind turbine components, such as a spinner, a nacelle housing, or part of a wind turbine tower.

Finally, as described herein and shown in the accompanying figures, the surface 20 of the composite body 10 may be an external surface, i.e. the dissociation fluid 24 may be applied to an external surface of the composite body 10. However, it should be understood that some examples of the method may be equally advantageously applied to reconditioning a surface 20 of a composite body 10 that is an internal surface, for example an interior surface 20 of a floating vessel or an interior surface of a composite wind turbine blade 10.

It will be appreciated that the description provided above serves to demonstrate a plurality of possible examples of the present invention. Features described in relation to any of the examples above may be readily combined with any other features described with reference to different examples without departing from the scope of the invention as defined in the appended claims.

1. A method of reconditioning a composite body comprising at least one layer of reinforcing material embedded in a thermoset epoxy matrix having a cross-linked network structure, the method comprising;
identifying a region of the composite body for reconditioning;
arranging a temporary barrier on a surface of the composite body to define an application area comprising the identified region;
applying a dissociation fluid to the surface of the composite body in the application area to at least partially degrade the thermoset epoxy matrix in the application area to thereby dissociate one or more layers of reinforcing material from the thermoset epoxy matrix.

2. The method of claim 1, wherein the dissociation fluid is a swelling fluid comprising formic acid, and wherein applying the dissociation fluid to the surface of the composite body in the application area comprises applying a swelling fluid to the composite body to swell the thermoset epoxy matrix in the application area.

3. The method of claim 1, wherein the dissociation fluid is a chemical disassembler fluid comprising acetic acid and/or formic acid.

4. The method of claim 1, wherein the identified region is a damaged region of the composite body, and wherein after applying the dissociation fluid to the surface of the composite body in the application area the method further comprises arranging one or more repair materials in the identified region.

5. The method of claim 4, wherein the one or more repair materials comprises epoxy resin, and wherein the epoxy resin is supplied to the application area.

6. The method of claim 5, wherein after applying the dissociation fluid to the application area and before supplying epoxy resin to the application area, the method further comprises activating the reinforcing material of the composite body in the application area.

7. The method of any of claims 4 to 6, wherein the repair materials comprise reinforcing material.

8. The method of claim 1, wherein the temporary barrier comprises sealing apparatus, and wherein the method comprises arranging the sealing apparatus to cover the identified region and engaging a seal of the sealing apparatus against the surface of the composite body.

9. The method of claim 1, further comprising:
assessing the application area to specify an amount of thermoset epoxy matrix for removal;
measuring a quantity of the dissociation fluid corresponding to the specified amount of thermoset epoxy matrix for removal; and
applying the measured quantity of dissociation fluid to the application area to remove a pre-specified amount of thermoset epoxy matrix.

10. The method of claim 1, wherein the dissociation fluid comprises at least one of a dissolved dye, a colourant, a pigment, or a UV sensitive component.

11. The method of claim 1, further comprising applying a neutralising agent to the composite body in the application area to neutralise the dissociation fluid and thereby stop the dissociation reaction between the dissociation fluid and the thermoset epoxy matrix.

12. The method of claim 1, wherein after applying the dissociation fluid to the surface of the composite body in the application area the method further comprises a mechanical cleaning process to remove substantially all dissociation fluid and/or debris from the identified region.

13. The method of claim 1, wherein the surface of the composite body is an external surface such that the dissociation fluid is applied to an external surface of the composite body.

14. The method of claim 1, wherein the composite body comprises a cover layer on the identified region, wherein the cover layer is inert to the dissociation fluid, the method further comprising:
removing the cover layer on the identified region prior to applying the disassociation fluid to the surface of the surface of the composite body,
and optionally apply a replacement cover layer after applying the dissociation fluid to the surface of the composite body in the application area.

15. The method of claim 1, wherein the composite body is a composite wind turbine blade.

16. The method of claim 1, wherein the composite body is a composite wind turbine blade comprising an aerodynamic outer profile extending in a chordwise direction between a leading edge and a trailing edge, wherein the leading edge defines a leading edge region, and wherein the method comprises identifying at least a part of the leading edge region as the identified region of the composite body for reconditioning, and arranging the temporary barrier on the surface of the composite body to define an application area comprising the leading edge and at least a part of the leading edge region.

17. The method of claim 16, wherein after applying the dissociation fluid to the surface of the composite body in the application area, the method further comprises attaching a leading edge protection component to the leading edge region of the composite wind turbine blade.
